(19) United States
(12) Patent Application Publication
(10) Pub. No.: US 2017/0259269 A1
(43) Pub. Date: Sep. 14, 2017

(54) HEATING HOOD APPARATUS HAVING A NOVEL TYPE OF ARRANGEMENT OF THE HEATING DEVICE

(71) Applicant: INNOVATIVE THERMOANALYTIC INSTRUMENTS KG, Hettenleidelheim (DE)

(72) Inventors: Andrea ALLES, Hettenleidelheim (DE); Keith STUART, Canvey Island, Essex (GB)

(73) Assignee: INNOVATIVE THERMOANALYTIC INSTRUMENTS KG, Hettenleidelheim (DE)

(21) Appl. No.: 15/509,673

(22) PCT Filed: Sep. 8, 2015
(86) PCT No.: PCT/EP2015/070446

§ 371 Date: Mar. 8, 2017

(30) Foreign Application Priority Data
Sep. 8, 2014 (DE) 202014007322.8

(51) Int. Cl. B01L 7/00; H05B 3/48; F27B 17/02

(52) U.S. Cl. CPC B01L 7/00; F27B 17/02; H05B 3/48; B01L 2300/1827; B01L 2300/0832; B01L 2300/1883; B01L 2300/1838

(57) ABSTRACT

A heating hood according to the disclosure comprises a spherically formed heat transfer region, in particular for receiving at least partially spherical objects; a frame device, wherein position of the heat transfer region is at least partially predefined by the frame device; and a heating device arranged between the heat transfer region and the frame device. A slit for guiding air is formed at least sectionally between the frame device and the heating device, wherein air can be introduced into the slit on a first side of the frame device, and wherein the introduced air can be diverted from the slit on another side, which is spaced apart in a longitudinal direction of the frame device.

According to claim 1, the invention at hand lies in the field of heating hoods.

Heating hoods are used in different technical areas, in particular in the pharmaceutical, chemical and metal recycling industry, e.g. in order to realize chemical and biological reactions or distillation processes.

Known heating hoods always have the problem that the heat introduction into the substance to be heated does not take place evenly. The heat generation further has the result that the entire heating hood in each case heats up very strongly, whereby there is a higher risk of damages to the ground, on which the heating hood stands, or whereby there is a high risk of injury to the users, who can come into contact with the exterior of the heating hood.

It is thus the object of the invention at hand to provide a heating hood, which provides for an even heating of the substance to be tempered in a heat transfer region and the external housing parts thereby experience a slighter heating.

According to the invention, the above-mentioned object is preferably solved by means of a heating hood according to claim 1. A heating hood or an apparatus for the tempering of substances, respectively, according to the invention preferably comprises at least one spherically formed heat transfer region, wherein the heat transfer region is preferably formed for receiving at least partially spherical objects, a frame device, wherein the position of the heat transfer region is at least partially predefined by the frame device, and preferably an at least sectionally tubularly formed heating device, wherein the heating device is arranged between the heat transfer region and the frame device, wherein the heating device at least partially encloses the heat transfer region in circumferential direction.

This solution is advantageous, because a highly uniform heat introduction into the transfer region can be effected by means of a tubular heating device, which at least partially enclosed the heat transfer region. Laboratory work, e.g., can be carried out more quickly and more accurately due to the more efficient or more accurate heat provision, respectively, in the heat transfer region.

The invention at hand also relates to a heating hood, which preferably comprises at least one spherically formed heat transfer region, in particular for receiving at least partially spherical objects, a frame device, wherein the position of the heat transfer region is at least partially predefined by the frame device, and a heating device. The heating device is preferably arranged between the heat transfer region and the frame device, wherein a slit for guiding air is formed at least sectionally between the frame device and the heating device, wherein air can be introduced into the slit on one side of the wall device and the frame device, wherein the introduced air can be diverted from the slit on a second side, which is spaced apart in longitudinal direction of the frame device or in orthogonal direction to the circumferential direction of the heat transfer region . The air is thus particularly preferably allowed to enter or conveyed or sucked into the heating hood in a lower region of the heating hood. The air is further blown out or conveyed out or guided out of the heating hood in an upper region of the heating hood. This solution is advantageous, because the air, which is guided through the heating hood, fulfills an isolating function on the one hand, whereby less of the heat generated by the heating device transfers to the frame device. The air, which is preferably moved in a chimney-like fashion, further conveys heat out of the heating hood. It is possible hereby that a blower device, in particular an electrically operated blower device, is provided in or on the heating hood for conveying the air. Due to the “chimney effect”, the frame device or the housing of the heating hood, respectively, can preferably be touched from the outside without injuries, even during a use of e.g. up to 450° C., 500° C., 550° C. or 600° C., thus ensuring high occupational safety.

Further preferred embodiments are the subject matter of the description below or of the subclaims.

According to a preferred embodiment of the invention at hand, the heating device encloses the heat transfer region tubularly at least once and preferably several times in circumferential direction. The heating device preferably encloses the heat transfer region, in particular spirally, exactly, at least or maximally twice, exactly, least or maximally 3 times, exactly, at least or maximally 4 times, exactly, at least or maximally 5 times, exactly, at least or maximally 6 times, exactly, at least or maximally 7 times, exactly, at least or maximally 8 times, exactly, at least or maximally 9 times, exactly, at least or maximally 10 times, exactly, at least or maximally 11 times, exactly, at least or maximally 12 times, exactly, at least or maximally 13 times, exactly, at least or maximally 14 times, exactly, at least or maximally 15 times, exactly, at least or maximally 16 times, exactly, at least or maximally 17 times, exactly, at least or maximally 18 times, exactly, at least or maximally 19 times or particularly preferably exactly, at least or maximally 20 times. This embodiment is advantageous, because a highly even tempering of the heat transfer region takes place or is possible, respectively, by means of the heating device, which encloses the heat transfer region.

According to a further preferred embodiment of the invention at hand, an electrical heating resistor extends at least sectionally and preferably across the entire length of the tubular portion of the heating device in the interior of the tubular heating device, wherein the electrical heating resistor is spaced apart from the wall of the heating device, which forms the tubular shape, by means of a filling material, in particular silicon dioxide. Provision is thus preferably made in the heating device, which is at least sectionally tubular, in particular in the tubular portion, for a filling material, by means of which the electrical heating resistor is spaced apart from the wall of the heating device. The filling material is hereby preferably silicon dioxide or preferably has silicon dioxide. Particularly preferably, the filling material consists mostly of silicon dioxide, in particular in terms of quantity and/or mass.

According to a further preferred embodiment of the invention at hand, the electrical heating resistor extends in an intermediate section between a front section and an end section of the tubular heating device, wherein the end section and/or the front section are preferably designed in such a manner that, in an operating state, in which current is applied to the electrical heating resistor, the average surface temperature of the tubular device in the intermediate section is greater than the average surface temperature of the tubular device in the front section and/or in the end section. This embodiment is advantageous, because, due to their lower operating temperature, the front section and the end section can be connected more easily to a further device, in particular a control device.

According to a further preferred embodiment of the invention at hand, the heating device is coupled to a manually actuatable control device. This embodiment is advantageous, because certain temperatures and/or temperature profiles can be set or predefined, respectively, by means of an actuation of the control device by the user.

According to a further preferred embodiment of the invention at hand, the tubular heating device is overlapped by a cover layer, which at least sectionally lines the heat transfer region, wherein the cover layer consists at least partially and, preferably in terms of mass, preferably mostly of glass fibers or of one or a plurality of glass fiber mats, respectively, or of glass fiber layer(s) and/or of one or a plurality of aramide fiber(s) or aramide mat(s), respectively. This embodiment is advantageous, because a protective layer, by means of which the heating device is protected against damages, is provided by means of the cover layer. The cover layer is further preferably embodied in a mat-like manner, whereby a collision of the cover layer with a tempering object, which is introduced in the heat transfer region, is damped. The tempering object is preferably a glass vessel, in particular a glass flask, for heating the substances stored therein.

According to a further preferred embodiment of the invention at hand, the tubular heating device is enclosed in circumferential direction by a wall device, which is coupled to the frame device, wherein preferably a means for thermal insulation is provided between the wall device and the tubular heating device. The means hereby preferably consists of an insulating material for preventing or reducing a heat transfer. In particular a heat transfer is thus reduced or prevented, respectively, e.g. by means of heat radiation or heat conduction.

According to a further preferred embodiment of the invention at hand, the wall device and the frame device are connected to one another by means of a plurality of coupling devices, which are at least sectionally thermally isolated, wherein a slit for guiding air is at least sectionally formed between the wall device and the frame device, wherein air can be introduced into the slit on one side of the wall device and of the frame device, wherein the introduced air can be diverted from the slit on a second side, which is spaced apart in longitudinal direction of the wall device and of the frame device. This embodiment is advantageous, because the air guided through the heating hood fulfills an isolating function on the one hand, whereby less of the heat, which is generated by the heating device, transfers to the frame device. The air, which is preferably moved in a chimney-like manner, further conveys heat out of the heating hood. It is possible hereby that a blower device, in particular an electrically driven blower device, is provided in or on the heating hood for conveying the air. Due to the “chimney effect”, the frame device or the housing of the heating hood, respectively, can preferably be touched from the outside without injuries, even during a use of e.g. up to 450° C., 500° C. or 550° C. , thus ensuring high occupational safety.

According to a further preferred embodiment of the invention at hand, the at least sectionally thermal isolation of the coupling devices is arranged in the region of the slit so as to embody a heat conductivity barrier between the frame device and the wall device. This embodiment is advantageous, because a heating of the frame device is prevented or reduced, respectively, as a result of heat conduction.

According to a further preferred embodiment of the invention at hand, bulk material, which is formed by bulk material granules, is arranged in the heat transfer region, in particular on the cover layer, wherein the bulk material can be repositioned as a result of a mechanical stress. In the context of the invention at hand, bulk material is understood as the totality of all solid particles or objects, respectively, which can be loosely poured into a receiving region. In the context of the invention at hand, fluids are explicitly not considered to be bulk material. The repositioning of the bulk material preferably takes place by bringing the bulk material into contact with an object to be tempered, in particular a glass body, such as, e.g., a test tube or a flask. This embodiment is advantageous, because the bulk material does not start to splash spontaneously as compared to a fluid, if unintended contaminations of the bulk material should occur. In contrast, hot oil has the properties e.g. that, when it comes into contact with water, it heats up the water so quickly that deflagrations of the water can occur. For example, this can occur in response to the breakage of the object to be tempered, whereby the liquid held available in the object to be tempered flows into the oil and is thus heated in an uncontrolled manner. The deflagration of the liquid, which is heated in an uncontrolled manner, can thereby cause the oil to spill, which results in a very high risk of injury to the operator. In contrast, the bulk material is significantly less susceptible to spilling or splashing due to its non-fluidic properties and preferably due to its higher density.

According to a further preferred embodiment of the invention at hand, the bulk material granules of the bulk material consist mostly of metal, wherein all bulk material granules preferably consist of metal, wherein the bulk material granules can consist of the same material or of different materials. This embodiment is advantageous, because the bulk material granules conduct heat very well due to their material properties and preferably have a larger density as compared to oil. The use of metal as bulk material granular material further has the advantages that it does not emit any odors and is not combustible. It further heats the objects to be tempered more quickly than oil.

According to a further preferred embodiment, the bulk material granules consist of metallic material, which has a heat conductivity of more than 10 W/(m*K), in particular of more than 30 W/(m*K) or of more than 50 W/(m*K) or of more than 80 W/(m*K) or of more than 109 W/(m*K) or of more than 119 W/(m*K) or of more than 150 W/(m*K) or of more than 200 W/(m*K) or of more than 230 W/(m*K) or of more than 350

W/(m*K) or of more than 400 W/(m*K) or of more than 420 W/(m*K), the metallic material preferably consists of one of the metals iron, zinc, brass, aluminum, gold, copper and/or silver or has one or a plurality of these metals. This embodiment is advantageous, because, depending on the field of application, the material selection, which is most suitable for the respective use, can be made by means of the heating hood.

According to a further preferred embodiment of the invention at hand, the plurality of the bulk material granules and preferably all bulk material granules have an at least partially spherical form, in particular a sphere-like form, wherein the diameter of the plurality of the bulk material granules and preferably of all bulk material granules is preferably smaller than 6 mm, in particular smaller than 5 mm or smaller than 4 mm or smaller than 3 mm or smaller than 2 mm or smaller than 1 mm. This embodiment is advantageous, because, in the case of smaller diameters, the remaining regions between the individual bulk material granules become smaller and because less air can thus be present in these regions. Due to the fact that air has a relatively low heat conductivity, it is preferably attempted to hold as little air as possible available in the region between the object to be tempered and the cover layer 24.

The invention at hand furthermore relates to a method for operating a heating hood, in particular according to a heating hood as described above and as will be described below. The method according to the invention preferably comprises at least the steps: providing a heating hood, introducing bulk material into the heat transfer region of the heating hood, positioning an object to be tempered across from the heating hood, wherein the object and the bulk material are brought into contact, tempering the bulk material by means of the heating hood and tempering the object to be tempered by means of the tempered bulk material.

The invention at hand can further relate to a use of bulk material in a heating hood.

The use of the word “substantially” in all cases, in which this word is used in the context of the property right at hand, preferably defines a deviation in the range of 1%-30%, in particular of 1%-20%, in particular of 1%-10%, in particular of 1%-5%, in particular of 1%-2%, from the provision, which would be at hand without the use of this word.

Individual or all illustrations of the figures described below are to preferably be considered to be design drawings, i.e. the dimensions, proportions, functional contexts and/or arrangement resulting from the figure or the figures, respectively, preferably correspond exactly or preferably substantially to those of the device according to the invention or of the product according to the invention, respectively.

Further advantages, goals and characteristics of the invention at hand will be explained by means of the below description of the attached drawings, in which heating hoods according to the invention are illustrated in an exemplary manner. Elements of the heating hoods according to the invention, which correspond at least substantially in the figures with respect to their function, can hereby be identified with the same reference numerals, wherein these components or elements, respectively, do not need to be numbered or explained, respectively, in all of the figures. The invention will be explained below merely in an exemplary manner by means of the enclosed figures.

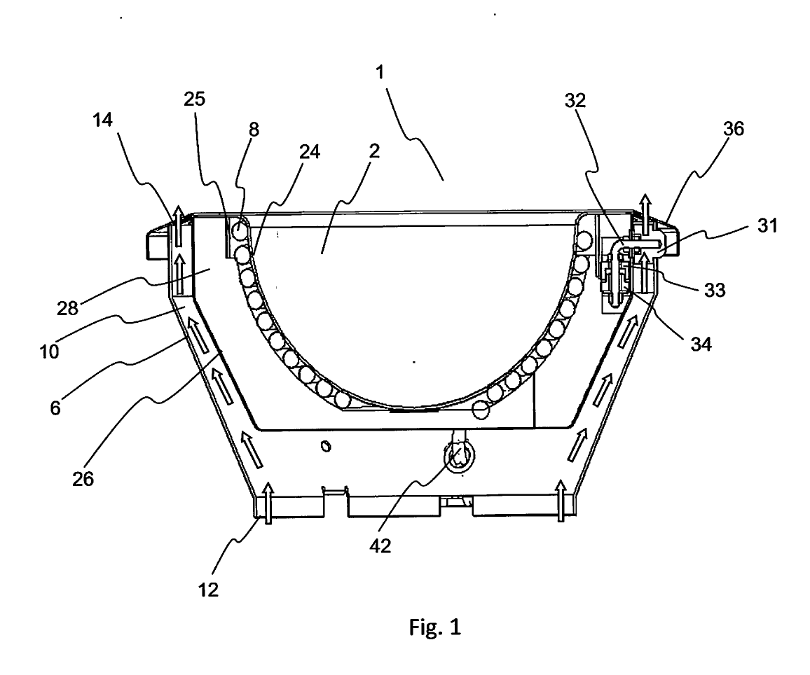

FIG. 1 shows a cross sectional illustration of the heating hood apparatus according to the invention;

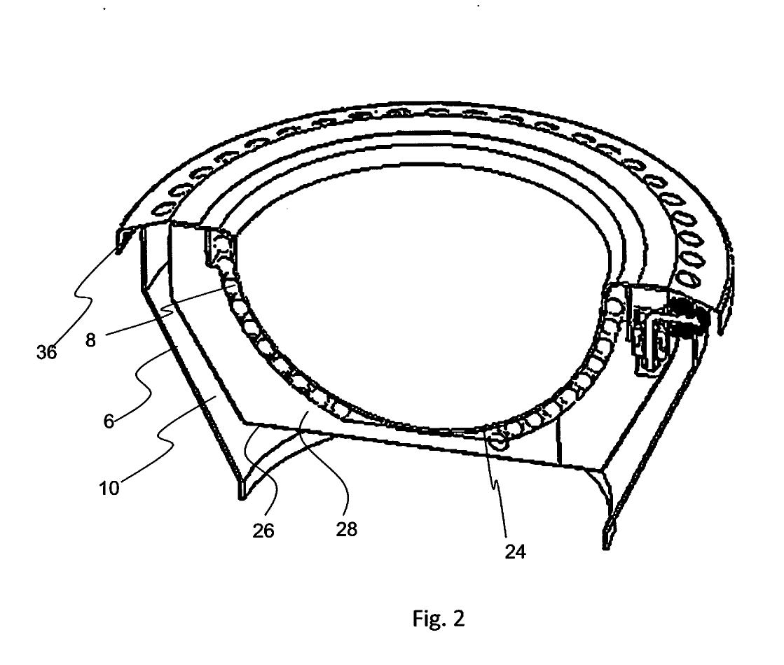

FIG. 2 shows a perspective view of a heating hood apparatus according to the invention in a sectional illustration;

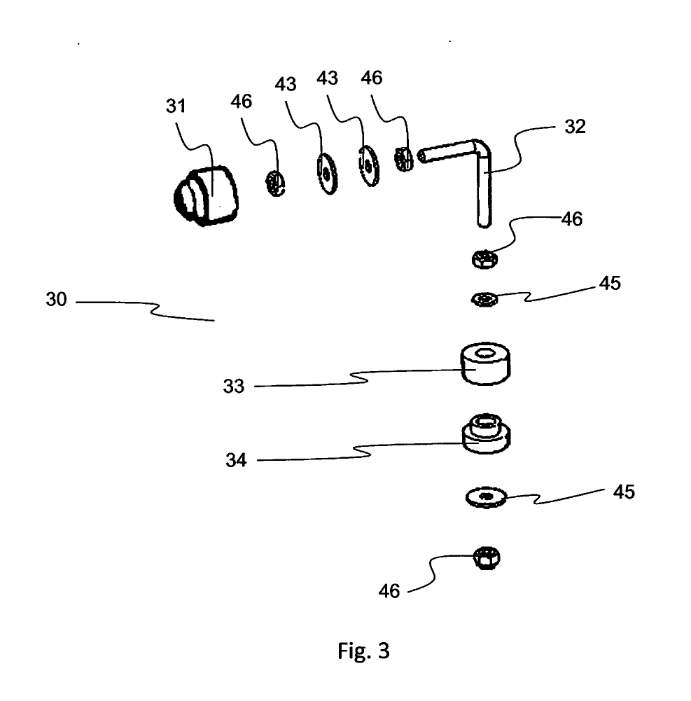

FIG. 3 shows a suspension device, as it is preferably used according to the heating hood apparatus according to the invention;

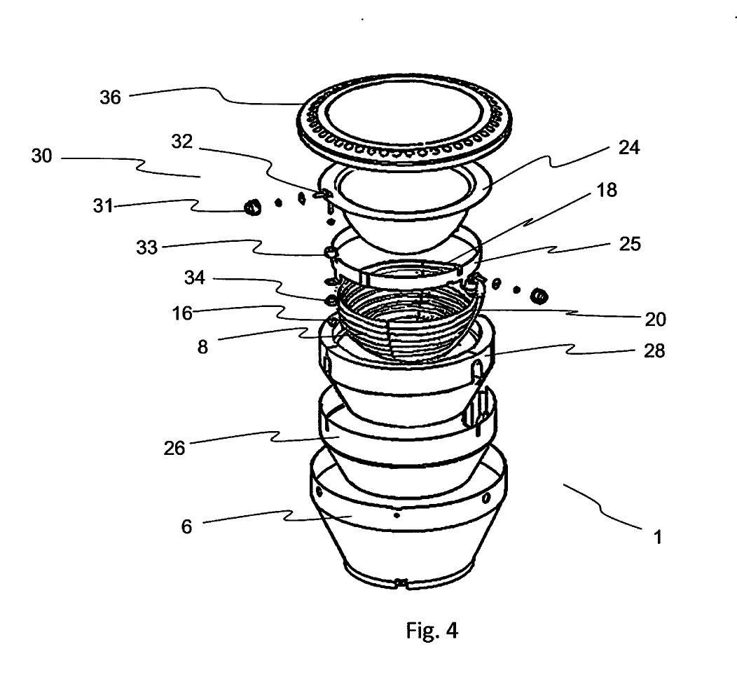

FIG. 4 shows an exploded illustration of the heating hood apparatus according to the invention;

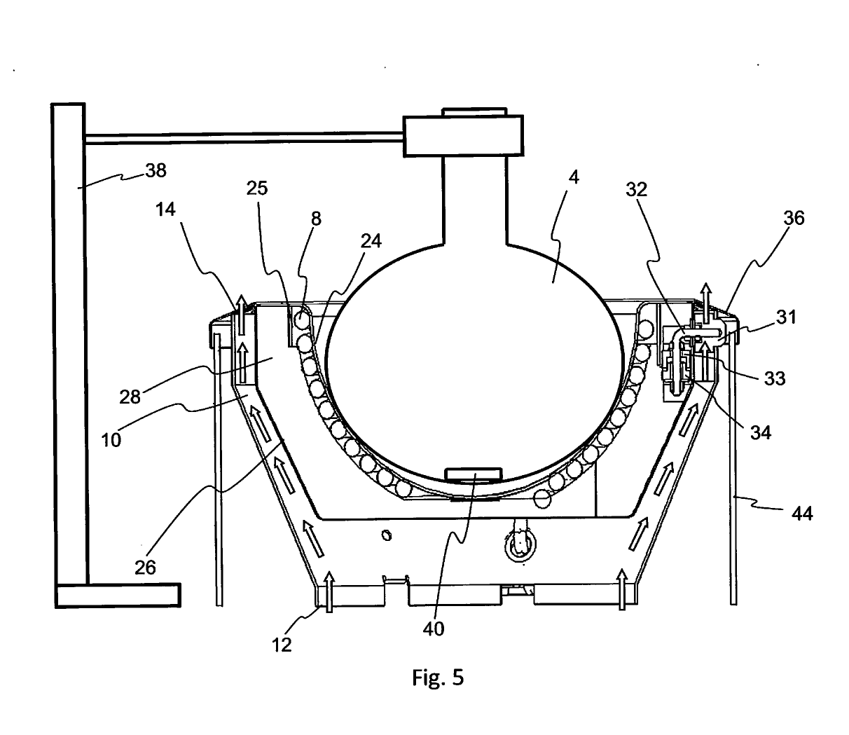

FIG. 5 shows an illustration according to FIG. 1, wherein a holding device and an object to be heated are illustrated as well;

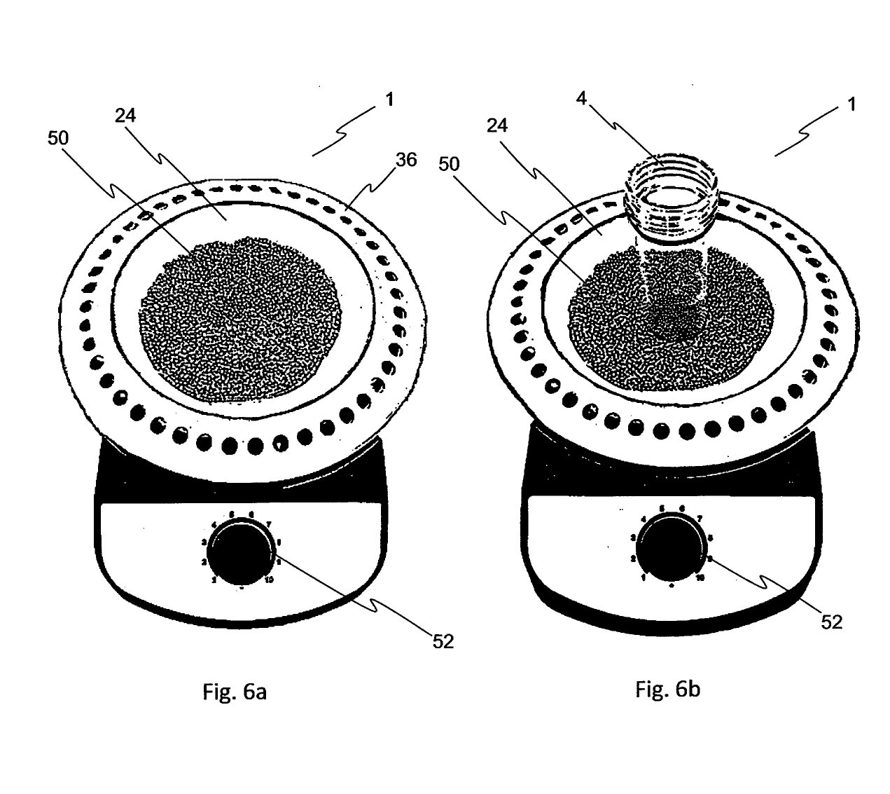

FIG. 6a shows an illustration of a heating hood according to the invention, which is equipped with bulk material, and

FIG. 6b shows a further illustration of a heating hood according to the invention, which is equipped with bulk material, wherein an object to be tempered is in contact with the bulk material.

FIG. 1 shows an example of a heating hood apparatus 1 according to the invention or a heating hood 1, respectively. The heating hood 1 has a heat transfer region 2, in which objects can be placed or arranged, respectively, for tempering. The heat transfer region 2 is at least sectionally defined by a cover layer 24. The cover layer 24 is hereby preferably a thin layer element, which preferably at least partially consists of glass fibers and/or of further or alternative materials. Thin hereby preferably describes a cross sectional thickness, which is less than 10 mm. The cover layer 24 hereby preferably has the function of covering the heating device 8. In addition or in the alternative, the cover layer 24 has the function of damping a contact between the heating hood and an object 4 (see FIG. 5), in particular a hollow glass body. The heating device 8 is preferably embodied as tubular mineral heater. An electrical resistor element or heating resistor, respectively, is preferably arranged in a metal tube hereby. The metal tube hereby preferably consists of steel, in particular of stainless steel. A filling material, in particular silicon dioxide, is further preferably arranged in the tube. Both ends of the tube are particularly preferably closed or sealed, respectively. The tube hereby preferably has a front section 18 (see FIG. 4), an end section 20 (see FIG. 4) and an intermediate section 16 (see

FIG. 4) arranged between the front section 18 and the end section 20. The end section 16 and the front section 18 preferably have line connectors, which are connected to a control device (not shown). The heating resistor or the heating element, respectively, preferably extend exclusively in the intermediate section 16 and thus spaced apart from the ends of the tube. The heating resistor or the heating element, respectively, is preferably spaced apart from the respective tube end by exactly, less or more than 20 mm, exactly, less or more than 40 mm, exactly, less or more than 80 mm, exactly, less or more than 100 mm, exactly, less or more than 120 mm, exactly, less or more than 140 mm, exactly, less or more than 200 mm, whereby the front section 18 and the end section 20 are embodied with a corresponding length. The front section 18 and the end section 20 preferably form connection regions, the average operating temperature of which is preferably less than the average operating temperature in the intermediate section 16. Loose connection ends of the front section 18 and of the end section 20 are preferably pressed and closed or sealed, respectively. An earthing connection or an earthing cable 42, respectively, is preferably furthermore arranged on the tubular element, in which the filling material and the resistor are arranged. Reference numeral 25 identifies a holding means for holding the heating device 8. The holding means 25 preferably has a plurality, in particular exactly, at least or maximally 2, exactly, at least or maximally 3, exactly, at least or maximally 4, exactly, at least or maximally 5, exactly, at least or maximally 6, exactly, at least or maximally 7 isolators. The isolators hereby preferably at least partially consist of a ceramic material. The individual isolators of the holding means 25 are preferably embodied as ceramic isolators. The individual isolators are preferably spaced apart from one another evenly or substantially evenly in circumferential direction of the holding means 25. The isolator can hereby preferably consist of a first isolator portion 33 and of a second isolator portion 34.

The heating device 8 is enclosed by a wall device 26 at least in circumferential direction. The wall device 26 thereby preferably serves to receive a means for thermally insulating 28 or filling material, respectively, or an insulating material, respectively, in particular glass wool or glass fiber material. The insulating material or the means for thermal insulating 28, respectively, is hereby preferably arranged between the heating device 8 and the wall device 26. The wall device 26 preferably forms a type of receiving trough or receiving container, respectively, which also serves to catch substances, which spilled or boiled over, and thus prevents these substances from coming into contact with the housing sleeve or the frame device 6, respectively.

The wall device 26 and the frame device 6 are oriented and arranged relative to one another in such a manner that a slit 10 is formed in a region between the wall device 26 and the frame device 6. The slit 10 thereby connects an air inlet, which is arranged on a first side 12 of the frame device 6, to an air outlet, which is arranged on a second side 14 of the frame device 6. The air inlet is preferably embodied in the region of the bottom of the heating hood apparatus 1, in particular on the underside of the heating hood apparatus 1. The frame device 6 is hereby preferably embodied in a funnel-shaped manner and at least indirectly and preferably directly supports the wall device 26 and/or the heating device 8 and/or the holding means 25. The slit 10 and the waste heat preferably create a chimney effect, through which cold air is absorbed via the air inlet. The absorbed air is moved through the slit 10 and is conveyed out of the heating hood apparatus 1 via the air outlet. The air thereby forms an isolation layer, by means of which a heat transfer of the heat of the heating device 8 to the frame device 6 is at least limited or reduced. The air conveyed through the heating hood apparatus 1, in particular through the slit 10, further has the effect that heat is received by the wall device 26 and is conveyed out of the heating hood apparatus 1. The slit 10 is hereby at least partially overlapped by a cover 36 on the upper side. The cover 36 preferably has a plurality of holes or openings, respectively, in particular more than 5, 10, 15 or more than 20 holes or openings, respectively, through which the air is guided out of the heating hood apparatus 1. The cover 36 is preferably embodied so as to be capable of being disassembled. The cover 36 preferably serves to cover transitions between individual devices, receiving device(s), fixing device(s) and/or connections between components, elements and/or devices. The cover layer 24 is preferably arranged on the cover 36, in particular arranged in a releasable or non-releasable manner. The first isolator portion 33 and the second isolator portion 34 of the individual ceramic isolators, which are in contact with the holding means 25, create a thermal separation between the holding means 25 and the suspension device 32. A heat transfer from the holding means 25 to the frame device 6 is prevented or at least reduced, respectively, by means of the thermal separation. The suspension device 32 preferably couples the holding means 25 to the frame device 6. The suspension device 32 preferably has the isolator portions and 34 on one end or in the region of one end, respectively. The suspension device 32 further has a further isolator device, in particular a slit isolator 31, preferably on a further end. In the shown application, the further isolator device is preferably arranged in the slit 10 and forms a thermal separation between the suspension device 32 and the frame device 6. The further isolator device or the slit isolator 31, respectively, preferably at least partially and preferably completely consists of polyether ether ketone (PEEK).

FIG. 2 shows a perspective view of the heating hood apparatus 1 shown in FIG. 1. The heating device 8 of the heating hood apparatus 1 is preferably embodied as tubular mineral heater. The design of the heating device 8 prevents in particular a fluid ingress and, due to its design, further provides the heating resistor with protection against overflowing liquids. It is a significant advantage of the heating device 8 that an undulated or meander-shaped, respectively, or wound up or partially or at least partially undulated, respectively, meander-shaped or wound-up heating element can be used therein. The heating element is thereby spaced apart from the inner wall of the tube, preferably by means of spacer elements 33, 34, in particular by means of ceramic spacer elements. The spacer elements 33, 34 can hereby consist of magnesium oxide and/or silicon dioxide, e.g., or can have magnesium oxide and/or silicon dioxide. The tube is preferably further filled at least partially and, in terms of quantity, particularly preferably mostly or completely with a filling material, in particular with silicon dioxide. An isolation between the inner tube wall and the heating element is preferably created by means of the filling material. A heat-conducting metallic tube comprising an inner diameter of between 2 mm and 30 mm, in particular of between 3 mm and 20 mm, in particular of between 3 mm and 15 mm, such as, e.g., 4 mm, 5 mm, 6 mm, 7 mm, 8 mm, 9 mm, 10 mm, 11 mm, 12 mm, 13 mm or 14 mm, thus preferably protects the heating element, in that particularly preferably a completely closed isolation of the heating element is created. The heating element is thus protected from liquid in such a manner that a substance, which spills or boils over, cannot come into contact with the heating element, in particular the heating resistor. On the basis of the described design, the used heating device 8 makes it possible to provide a heating hood apparatus 1, which can be operated without a specific circuit protection device in the supply line before current enters the device. A heating element, in particular an electric heating resistor, thus extends at least sectionally in the interior of the tubular heating device 8, whereby the heating element is spaced apart from the wall of the heating device 8, which forms the tubular shape, by means of a filling material, in particular silicon dioxide or magnesium oxide and/or by means of spacer elements.

A coupling device 30, which is formed as suspension device 32, is shown in FIG. 3. The suspension device 32 thereby has two washers 43 and two nuts 46, preferably in the horizontal part of the slit isolator 31. The washers 43 can preferably be positioned relative to one another in such a manner by means of the nuts 46 that a frictional connection with a further device, in particular the wall device 26 (see FIG. 1) results. A first isolator portion 33 and a second isolator portion 34 are preferably arranged in the vertical portion of the suspension device 32, wherein the isolator portions 33 and 34 can be positioned relative to one another, preferably by means of washers 45 and nuts 46. The isolator portions 33 and 34 are preferably positioned relative to one another in such a manner that they fix, in particular clamp, a further device, in particular the holding means 25. The setup of the suspension device 32 has the effect that the heat in the region of the heating device 8 does not transfer to a housing 44 (see FIG. 5), which surrounds the frame device 6, as a result of heat conduction or in a reduced manner, respectively. The preferably ceramic isolators 33, 34 initially have the effect that the heat does not transfer or in a reduced manner, respectively, from the holding means 25 to the receiving device 32. The slit isolator 31 further has the effect that the heat does not transfer or in a reduced manner, respectively, from the receiving device 32 to the frame device 6.

FIG. 4 shows an exploded illustration of a heating hood apparatus 1 according to the invention. It can be seen thereby that the heating device 6 is preferably arranged between three markers of the holding device 25, which are particularly preferably arranged so as to be distributed evenly in circumferential direction, a fixation is hereby preferably not necessary. Preferably, three isolators, in particular of ceramic material or having ceramic material, are arranged in three mounting devices around the holding means 25. One suspension device 32 is preferably in each case arranged in every ceramic isolator and is arranged evenly in circumferential direction of the holding means 25. The suspension devices 32 are preferably connected to the isolator via nuts, in particular M2 or M3 or M4 or M5 or M6. The heating device 8 is preferably overlapped by means of a preferably pre-assembled and particularly preferably preformed insulating device 28, in particular a glass fiber mat made of glass fiber material. The insulating device 28, in turn, is preferably overlapped by the wall device 26. The wall device 26 preferably consists of a material or material mixture, in particular at least partially and, in terms of mass, preferably mostly and particularly preferably completely of aluminum. The wall device 26 is preferably clamped and thus secured between flat washers 43 (see FIG. 3) in horizontal regions of the individual suspension devices 32. An isolator, in particular the slit isolator 31, is in each case arranged on the horizontal portion of the suspension devices 32 in the region of an end of the suspension devices 32 or on the end of the suspension devices 32. The isolator hereby preferably consists of polyether ether ketone. The isolators, which are in each case arranged in the horizontal portion of the suspension devices 32, are arranged in holes in the frame device 6. The cover 36 is attached to the heating hood apparatus 1, preferably after the connection of the suspension devices 32 to the frame device 6. The individual parts shown in FIG. 4 can preferably be exchanged individually, whereby it is also possible for a plurality of the shown parts to be exchangeable as component group.

The wall device 26 preferably consists of a metal or sheet metal, respectively, or of a metal mixture or metal mixture sheet metal, respectively. Particularly preferably, the wall device 26 consists at least partially or, in terms of mass, preferably mostly of aluminum. The frame device 6 preferably consists or a metal or of a metal mixture. Particularly preferably, the frame device 6 consists at least partially or, in terms of mass, preferably mostly of steel, in particular of stainless steel. The suspension device 32 preferably consists of a metal or of a metal mixture. Particularly preferably, the suspension device 32 consists at least partially or, in terms of mass, preferably mostly of steel, in particular of stainless steel. The cover 36 preferably consists of a metal or of a metal mixture. Particularly preferably the cover 36 consists at least partially or, in terms of mass, preferably mostly of steel, in particular of stainless steel.

The arrangement from FIG. 1 is shown in FIG. 5, wherein the illustration has been supplemented by a housing 44, a holding device 38 and an object 4. The holding device 38 hereby preferably serves for the defined holding of the object 4, which can preferably be a flask, in particular a glass flask.

The heating hood according to the invention has a multi-functional design of a chemical-resistant housing. The innovative setup of the heating hood 1 ensures a more efficient heat exchange between the heating device 8 and the glass flaks, so that laboratory work can be performed more quickly and more accurately. A “chimney effect” furthermore results from the design according to the invention during operation of the heating hood, whereby the housing can always be touched—also during use—from outside, thus resulting in high occupational safety. The heating hood 1 can furthermore be operated easily and is highly efficient. An exact and vigorous mixing can further be effected by means of an electromagnetic stirring component.

FIG. 6a shows a heating hood 1 according to the invention. The heating hood 1 has a cover layer 24, which defines the heat transfer region 2 towards the heating device 8. The cover layer 24 is hereby preferably sectionally and preferably completely formed by means of a preferably flexible fabric or a preferably flexible net. The cover layer 24 is hereby sectionally overlapped by a cover, preferably on the upper side. According to this illustration, a bulk material 50, which preferably consists of metallic balls or steel balls, respectively, or aluminum balls or also of other substantially spherical or cube-shaped bulk material of metal, is held in the heat transfer region 2, in particular by means of the cover layer 24. A tempering of the heat transfer region 2 thus effects a tempering of the bulk material.

Reference numeral 52 identifies an optional setting device, by means of which the heating output of the heating device 8 can preferably be influenced or regulated, respectively.

As compared to FIG. 6a, FIG. 6b also shows an object 4 to be tempered, in particular a test tube or a flask, which is at least sectionally surrounded so as to be contacted by the bulk material 50, in a region, in which a substance to be tempered is held available.

The invention refers to a heating hood. The heating hood according to the invention comprises at least one spherically formed heat transfer region, in particular for receiving at least partially spherical objects, a frame device, wherein the position of the heat transfer region is at least partially predefined by the frame device, and an at least sectionally tubularly formed heating device, wherein the heating device is arranged between the heat transfer region and the frame device, wherein the heating device at least partially encloses the heat transfer region in circumferential direction.

### REFERENCE LIST

1. heating hood
2. heat transfer region
4. object
6. frame device
8. heating device
10. slit
12. first side
14. second side
16. intermediate section
18. front section
20. end section
22. control device
24. cover layer
25. holding means
26. wall device
28. means for thermal insulation
30. coupling device
31. slit isolator
32. suspension device
33. first isolator portion
34. second isolator portion
36. cover
38. holding device
40. magnetic element
42. earthing cable
43. washer
44. housing
45. washer
46. nut
50. bulk material
52. setting element

1-15. (canceled)

16. A heating hood comprising:
a spherically formed heat transfer region for receiving at least partially spherical objects;
a frame device, wherein position of the heat transfer region is at least partially predefined by the frame device; and
a heating device arranged between the heat transfer region and the frame device;
wherein a slit for guiding air is formed at least sectionally between the frame device and the heating device, wherein air can be introduced into the slit on a first side of the frame device, and wherein the introduced air can be diverted from the slit on another side, which is spaced apart in a longitudinal direction of the frame device.

17. The heating hood according to claim 16 wherein the heating device encloses the heat transfer region at least once and preferably several times in a circumferential direction.

18. The heating hood according to claim 16 wherein a heating element extends at least sectionally in an interior of the heating device.

19. The heating hood according to claim 18 wherein the heating device has a tubular shape, and the heating element comprises an electrical heating resistor that is spaced apart from a wall of the heating device, which forms the tubular shape, by means of a filling material and/or by means of spacer elements.

20. The heating hood according to claim 19 wherein the filling material comprises silicon dioxide or magnesium oxide.

21. The heating hood according to claim 19 wherein the electrical heating resistor extends in an intermediate section between a front section and an end section of the tubular heating device, wherein the end section and/or the front section are/is designed in such a manner that, in an operating state in which current is applied to the electrical heating resistor, average surface temperature of the tubular heating device in the intermediate section is greater than average surface temperature of the tubular heating device in the front section and/or in the end section.

22. The heating hood according to claim 16 wherein the heating device is coupled to a manually actuatable control device.

23. The heating hood according to claim 16 wherein the heating device is overlapped by a cover layer, which at least sectionally lines the heat transfer region, and wherein the cover layer preferably consists at least partially of glass fibers.

24. The heating hood according to claim 16 wherein the heating device is enclosed in a circumferential direction by a wall device, which is coupled to the frame device.

25. The heating hood according to claim 24 wherein a means for thermal insulation is provided between the wall device and the heating device.

25. The heating hood according to claim 24 wherein the wall device and the frame device are connected to one another by a plurality of coupling devices, which are at least sectionally thermally isolated, wherein the slit for guiding air is at least sectionally formed between the wall device and the frame device.

26. The heating hood according to claim 25 wherein the at least sectionally thermal isolation of the coupling devices is arranged in the region of the slit so as to embody a heat conductivity barrier between the frame device and the wall device.

27. The heating hood according to claim 16 wherein bulk material, which is formed by bulk material granules, is arranged in the heat transfer region, and wherein the bulk material can be repositioned as a result of a mechanical stress.

28. The heating hood according to claim 27 wherein the bulk material granules of the bulk material comprise metallic material.

29. The heating hood according to claim 28 wherein the bulk material granules comprise metallic material, which has a heat conductivity of more than 10 W/(m*K).

30. The heating hood according to claim 28 wherein the bulk material granules comprise metallic material, which has a heat conductivity of more than 420 W/(m*K),

31. The heating hood according to claim 28 wherein the metallic material comprises one or more of iron, zinc, brass, aluminum, gold, copper, silver.

32. The heating hood according to claim 28 wherein multiple bulk material granules each have an at least partially spherical form and a diameter smaller than 6 mm.

33. A method for operating a heating hood, the method comprising:
providing a heating hood;
introducing bulk material into a heat transfer region of the heating hood;
positioning an object to be tempered across from the heating hood, wherein the object and the bulk material are brought into contact; and
tempering the bulk material by means of the heating hood and tempering the object to be tempered by means of the tempered bulk material.
